(19) United States
(12) Patent Application Publication
(10) Pub. No.: US 2023/0035319 A1
(43) Pub. Date: Feb. 2, 2023

(54) Dynamically Masking Event Processing Requests Using a Machine Learning Model

(71) Applicant: Bank of America Corporation, Charlotte, NC (US)

(72) Inventors: Marie Andrade, Charlotte, NC (US); Monika Kapur, Jacksonville, FL (US)

(21) Appl. No.: 17/386,690

(22) Filed: Jul. 28, 2021

(51) Int. Cl. G06Q 40/00; G06N 20/00; G06N 5/04; G06Q 30/02; H04L 9/30

(52) U.S. Cl. CPC G06Q 40/12; G06N 20/00; G06N 5/04; G06Q 30/0201; H04L 9/30; G06Q 2220/10; G06Q 20/3221

(57) ABSTRACT

Aspects of the disclosure relate to a dynamic information masking computing platform. The dynamic information masking computing platform may receive an event processing request from a device corresponding to a first user via a merchant device. The dynamic information masking computing platform may generate masking decision data using a machine learning masking model. The dynamic information masking computing platform may receive a request for account information corresponding to the first user from a device corresponding to a second user. The dynamic information masking computing platform may mask the account information based on the masking decision data. The dynamic information masking computing platform may send the masked account information and commands directing the device corresponding to the second user to display an account interface that includes the masked record.

### BACKGROUND

Aspects of the disclosure relate to an information masking computing platform. In some instances, one individual may wish to conceal some or all of their account activity from other individuals. In some cases, however, multiple individuals may share a joint account, which may make account activity for both individuals visible to each other. It may be difficult to conceal such information from other shared account holders without alerting such individuals. In some instances, this may negatively impact user experience and may discourage individuals from opening a joint account.

### SUMMARY

Aspects of the disclosure provide effective, efficient, scalable, and convenient technical solutions that address and overcome the technical problems associated with conventional event processing storage systems. In accordance with one or more embodiments of the disclosure, a computing platform with at least one processor, a communication interface, and memory storing computer-readable instructions may receive an event processing request from a device corresponding to a first user. The event processing request may be received via a merchant device. The computing platform may generate masking decision data indicating that a record of the event processing request should be masked, using a machine learning masking model. The computing platform may receive a request for account information corresponding to the first user from a device corresponding to a second user, where the account information includes the record of the event processing request. The computing platform may mask the record of the event processing request based on the masking decision data. The computing platform may also send the masked record and one or more commands that direct the device corresponding to the second user to display an account interface to the device corresponding to the second user. The account interface may include the masked record. Sending the masked record and one or more commands may cause the device corresponding to the second user to display the account interface that includes the masked record.

In one or more instances, the computing platform may generate a mask label corresponding to the masking decision data using the machine learning masking model. The mask label may also correspond to the record of the event processing request. The mask label may be generated based on historical event masking information.

In one or more examples, the historical event masking information may be one or more of: past transactions made by the first user and/or masking decision data indicating whether or not to mask the past transactions made by the first user. In one or more instances, the historical event masking information may be past transactions made by a third user, different than the first user and the second user. The third user may correspond to a same geographic region as the first user. Additionally or alternatively, the historical event masking information may be masking decision data, made by the third user, indicating whether or not to mask the past transactions.

In one or more instances, the computing platform may use the machine learning masking model to place the record of the event processing request in a category of transaction types, based on the mask label. Placing the record of the event processing request into the category of transaction types may cause the record of the event processing request to receive a particular mask label, based on a corresponding category.

In one or more examples, the machine learning masking model may receive labeling information from the first user identifying the category of transaction types. In one or more instances, the machine learning masking model may identify the category of transaction types based on a type of merchant corresponding to the merchant device.

In one or more examples, the device corresponding to the second user may be the same as the device corresponding to the first user. In one or more instances, the second user may be an authorized account holder on an account shared with the first user.

In one or more examples, the computing platform may identify, based on a second user profile, whether the record of the event processing request should be masked for the second user profile. The second user profile may correspond to the second user. A first user profile may exist, and the first user profile may correspond to the first user.

In one or more instances, the computing platform may identify, based on the device corresponding to the second user, whether the record of the event processing request should be masked for the device corresponding to the second user. In one or more examples, the computing platform may encrypt the masked record of the event processing request. The computing platform may identify, based on whether or not the second user possesses an encryption key corresponding to the encrypted masked record, whether the record of the event processing request should be masked for the second user.

In one or more examples, the computing platform may receive historical event masking information from an event processing storage system. The computing platform may train the machine learning masking model using the historical event masking information. The training may include implementing an algorithm to identify a confidence score. The algorithm may include dividing a number of prior masked records corresponding to a same record type for the first user by a total number of records corresponding to the same record type. The training may also include comparing the confidence score to a confidence threshold, where records of event processing requests are masked if the confidence score exceeds the confidence threshold and records of event processing requests are not masked if the confidence score does not exceed the confidence threshold.

In one or more instances, the algorithm may further include adding a number of prior masked records for a separate user corresponding to a same demographic group as the first user to the number of prior masked records for the first user to generate a sum. The algorithm may further include dividing the sum by a total number of records of the same record type.

In one or more examples, the computing platform may compare the confidence score to a second confidence threshold lower than the first confidence threshold. Based on identifying that the confidence score fails to exceed the confidence threshold, the computing platform may modify the masking decision data, indicating that the record of the event processing request should not be masked.

In one or more instances, based on identifying that the confidence score does not exceed the first confidence threshold but does exceed the second confidence threshold, the computing platform may send one or more display commands to the device corresponding to the first user. The one or more display commands may cause the device corresponding to the first user to display a masking recommendation interface, where the masking recommendation interface is configured to receive user input.

In one or more instances, the computing platform may update the machine learning masking model based on the event processing request and the masking decision data. In one or more examples, the computing platform may store corresponding mask labels with corresponding records of event processing requests.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for dynamically masking event processing requests using a machine learning model in accordance with one or more example embodiments;

FIGS. 2A-2J depict an illustrative event sequence for dynamically masking event processing requests using a machine learning model in accordance with one or more example embodiments;

FIGS. 3A-3D depict illustrative graphical user interfaces for dynamically masking event processing requests using a machine learning model in accordance with one or more example embodiments; and

FIGS. 4A-4B depict an illustrative method for dynamically masking event processing requests using a machine learning model in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances, other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Some aspects of the disclosure relate to a system for masking private information. Users of an application or service (that may, e.g., be managed by an enterprise organization such as a financial institution) may desire more anonymity and privacy around their activity (e.g., transactions). Accordingly, systems may hide or mask various transactions based on, for instance, user preferences. For example, a user may customize options for hiding or masking one or more transactions or purchases, or modifying an appearance of a transaction or purchase on a statement, a list of transactions displayed via mobile or online banking, and/or other user preferences. In some examples, one or more transactions may be masked to one user of a joint account but visible to another. In some instances, the system may use encryption to enable the masking. This may also be used to hide transactions if in a potentially unsafe situation.

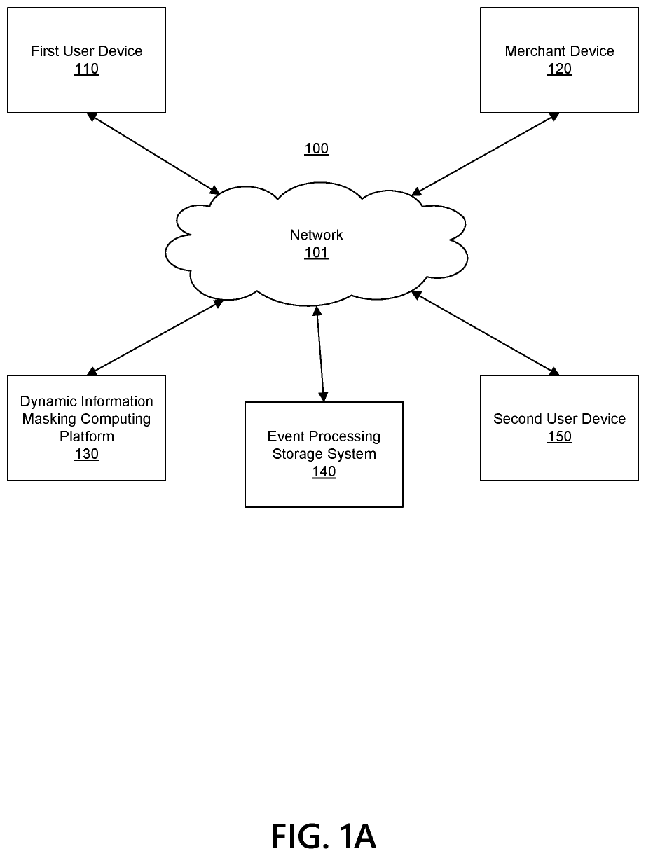

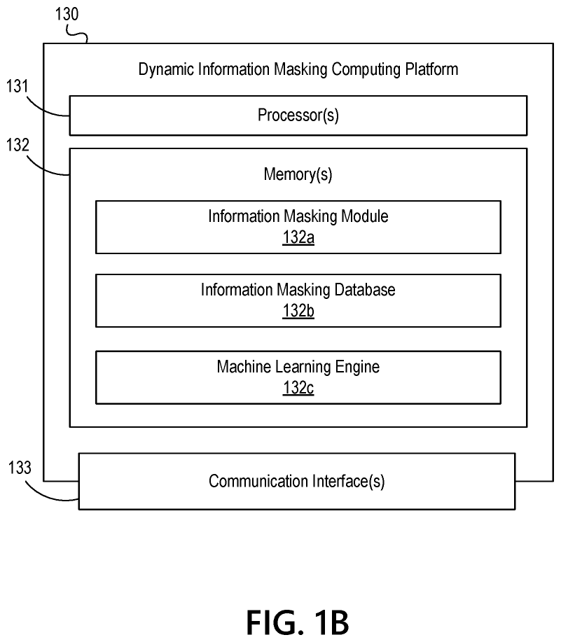

FIGS. 1A-1B depict an illustrative computing environment for dynamically masking event processing requests using a machine learning model in accordance with one or more example embodiments. Referring to FIG. 1A, computing environment 100 may include one or more computer systems. For example, computing environment 100 may include a first user device 110, a merchant device 120, a dynamic information masking computing platform 130, an event processing storage system 140, and a second user device 150.

First user device 110 may be a computing device (e.g., laptop computer, desktop computer, mobile device, tablet, smartphone, credit card reader, or other computing device) and/or other computer components (e.g., processors, memories, communication interfaces) that may be used to perform enterprise operations and/or provide user functions (e.g., information masking or other functions). In one or more instances, the first user device 110 may correspond to a first user (who may e.g., be a customer/client of an enterprise organization such as a financial institution).

In one or more instances, first user device 110 may be configured to communicate with dynamic information masking computing platform 130 for machine learning masking model configuration/training, information masking module execution, mask label generation, and/or to perform other functions. In some instances, the first user device 110 may be configured to display one or more graphical user interfaces (e.g., mobile banking interfaces, event processing interfaces, transaction execution interfaces, and/or other interfaces).

Merchant device 120 may be a computing device (e.g., laptop computer, desktop computer, mobile device, tablet, smartphone, credit card reader, and/or other device) and/or other computer components (e.g., processors, memories, communication interfaces) that may be used to perform enterprise operations and/or provide user functions (e.g., event processing and/or other functions). In one or more instances, the merchant device 120 may be configured to communicate with one or more user devices (e.g., first user device 110, second user device 150, and/or other devices) to process events (e.g., execute transactions) and/or to perform other functions.

As described further below, dynamic information masking computing platform 130 may be a computer system that includes one or more computing devices (e.g., servers, server blades, or the like) and/or other computer components (e.g., processors, memories, communication interfaces) that may be used to configure and train one or more machine learning masking models. In some instances, dynamic information masking computing platform 130 may be controlled or otherwise maintained by an enterprise organization such as a financial institution.

Event processing storage system 140 may be or include one or more servers or computer systems that store one or more databases. The data stored in the databases of event processing storage system 140 may include any of the records (e.g., event processing/transaction records) stored in and/or created by first user device 110, second user device 150, and/or any additional data. The databases stored on event processing storage system 140 may be accessed by and/or modified by any of, first user device 110, dynamic information masking computing platform 130, and second user device 150.

Second user device 150 may be a computing device (e.g., laptop computer, desktop computer, mobile device, tablet, smartphone, credit card reader, or other computing device) and/or other computer components (e.g., processors, memories, communication interfaces) similar to first user device 110 that may be used to perform enterprise operations and/or provide user functions (e.g., information masking or other functions). In one or more instances, the second user device 150 may correspond to a second user (who may e.g., be a customer/client of an enterprise organization such as a financial institution). In one or more instances, the second user may be different than the first user. In one or more instances, second user device 150 may be configured to communicate with dynamic information masking computing platform 130 for machine learning masking model configuration/training, information masking module execution, mask label generation, and/or to perform other functions. In some instances, the second user device 150 may be configured to display one or more graphical user interfaces (e.g., mobile banking interfaces, event processing interfaces, transaction execution interfaces, and/or other interfaces).

Computing environment 100 also may include one or more networks, which may interconnect first user device 110, merchant device 120, dynamic information masking computing platform 130, event processing storage system 140, and second user device 150. For example, computing environment 100 may include a network 101 (which may interconnect, e.g., first user device 110, merchant device 120, dynamic information masking computing platform 130, event processing storage system 140, and second user device 150).

In one or more arrangements, first user device 110, merchant device 120, dynamic information masking computing platform 130, event processing storage system 140, and second user device 150 may be any type of computing device capable of sending and/or receiving requests and processing the requests accordingly. For example, first user device 110, merchant device 120, dynamic information masking computing platform 130, event processing storage system 140, second user device 150, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of first user device 110, merchant device 120, dynamic information masking computing platform 130, event processing storage system 140, and second user device 150, may, in some instances, be special-purpose computing devices configured to perform specific functions.

Referring to FIG. 1B, dynamic information masking computing platform 130 may include one or more processors 131, memory 132, and communication interface 133. A data bus may interconnect processor 131, memory 132, and communication interface 133. Communication interface 133 may be a network interface configured to support communication between dynamic information masking computing platform 130 and one or more networks (e.g., network 101, or the like). Communication interface 133 may be communicatively coupled to the processor 131. Memory 132 may include one or more program modules having instructions that when executed by processor 131 cause dynamic information masking computing platform 130 to perform one or more functions described herein and/or one or more databases that may store and/or otherwise maintain information which may be used by such program modules and/or processor 131. In some instances, the one or more program modules and/or databases may be stored by and/or maintained in different memory units of dynamic information masking computing platform 130 and/or by different computing devices that may form and/or otherwise make up dynamic information masking computing platform 130. For example, memory 132 may have, host, store, and/or include information masking module 132a, information masking database 132b, and machine learning engine 132c.

Information masking module 132a may have instructions that direct and/or cause dynamic information masking computing platform 130 to dynamically mask event processing requests using a machine learning model. Information masking database 132b may have instructions causing dynamic information masking computing platform 130 to store historical event masking information (that may, e.g., be used to dynamically mask event processing requests using a machine learning model). Machine learning engine 132c may contain instructions causing dynamic information masking computing platform 130 to train and/or implement a machine learning model (that may, e.g., be used to dynamically mask event processing requests). In some instances, machine learning engine 132c may be used by dynamic information masking computing platform 130 and/or information masking module 132a to refine and/or otherwise update methods for information masking, and/or other methods described herein.

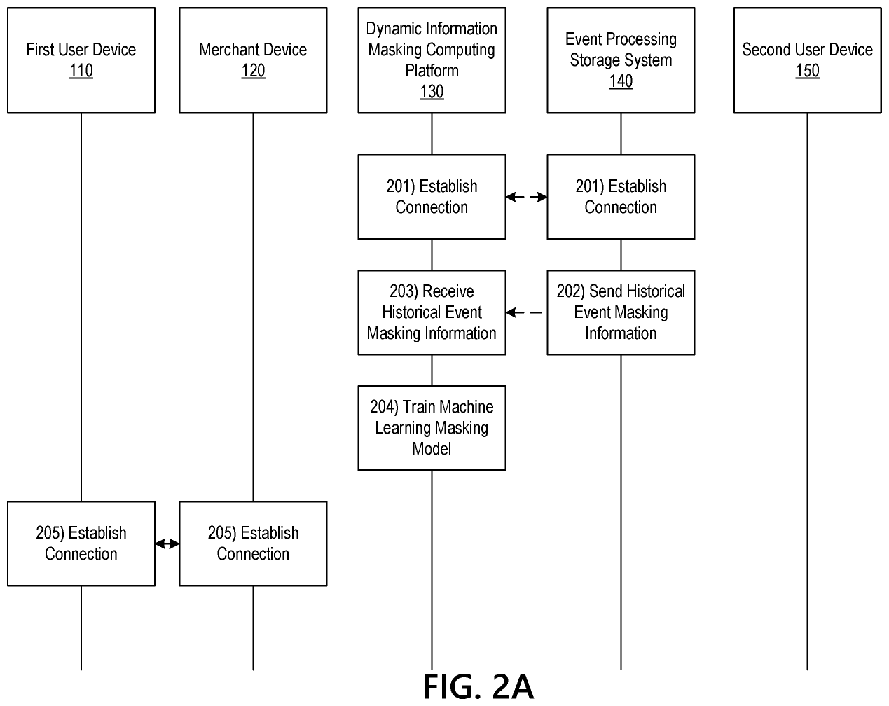

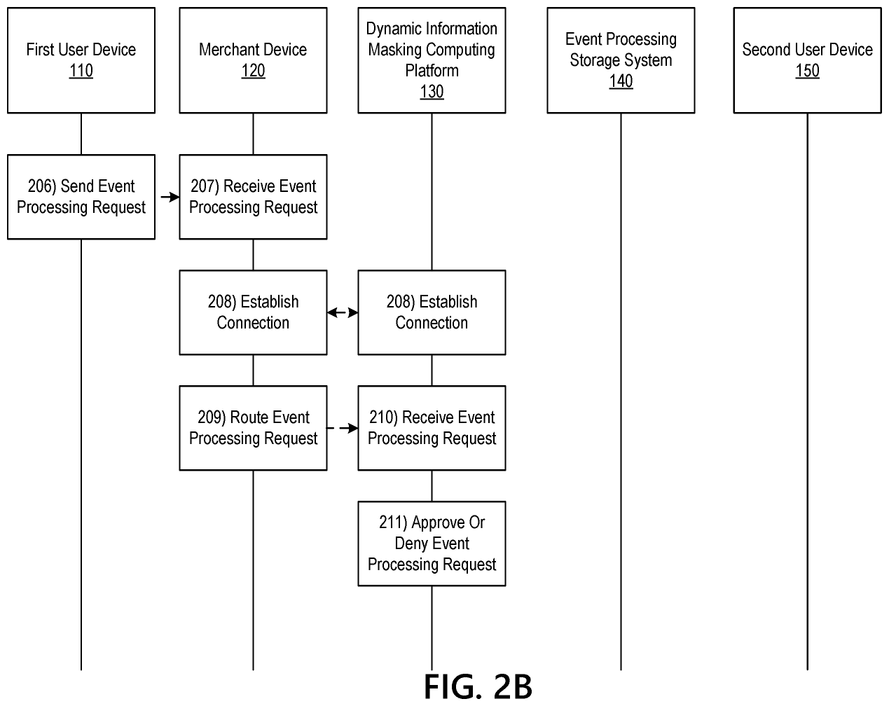

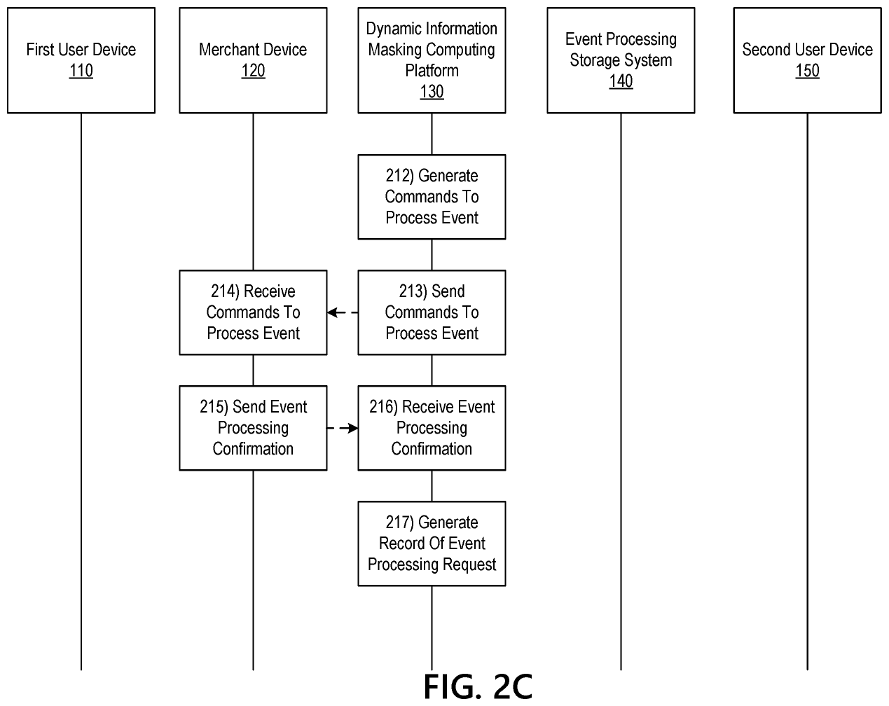

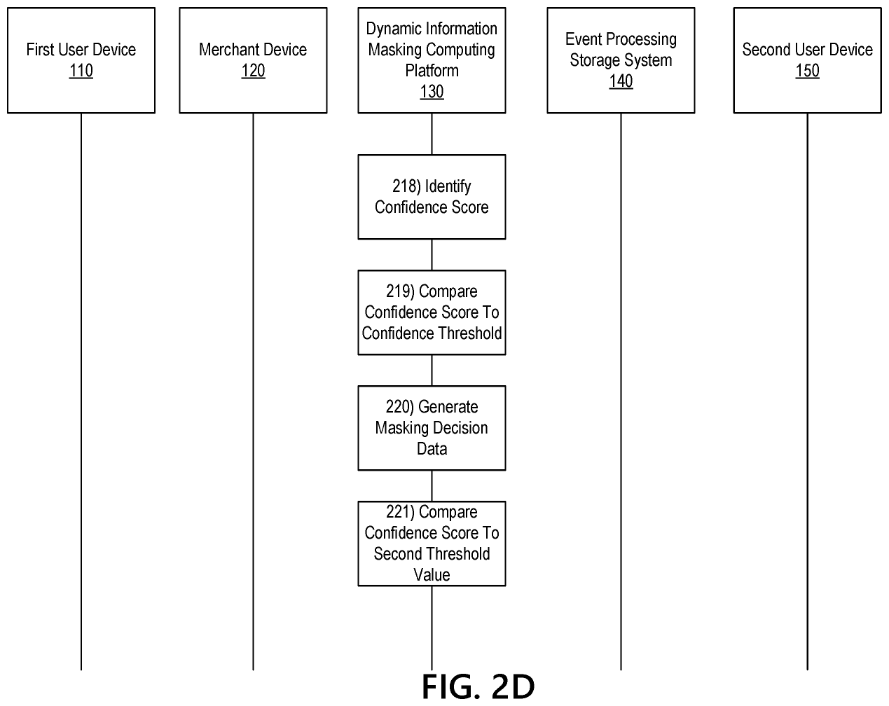

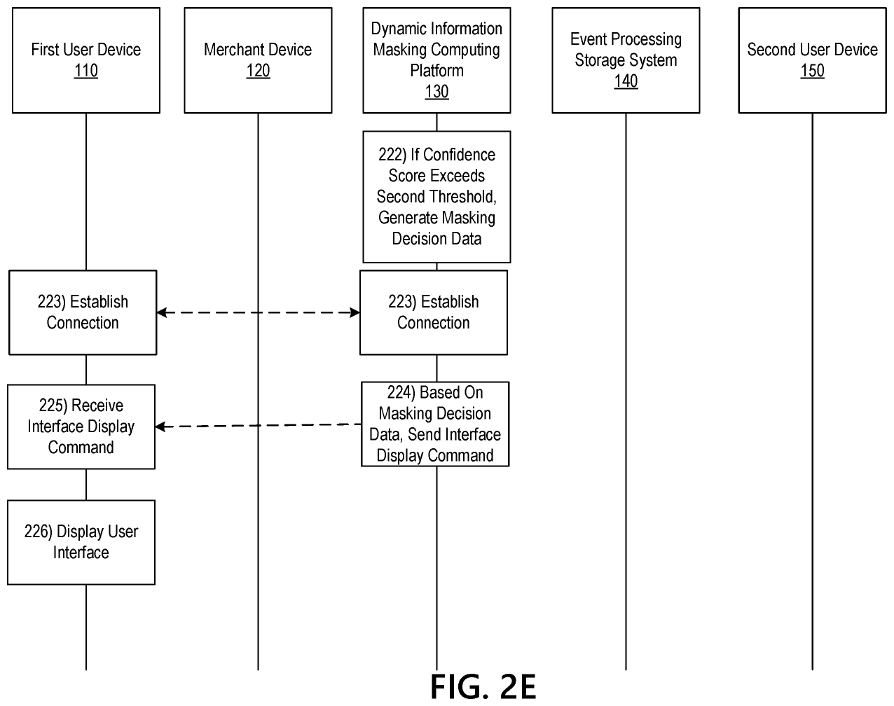

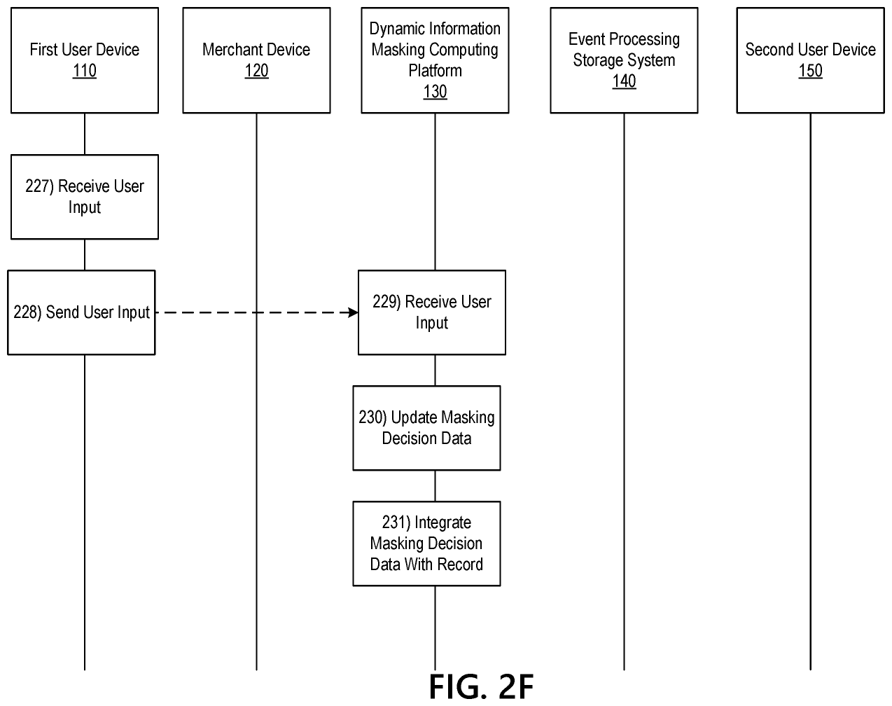

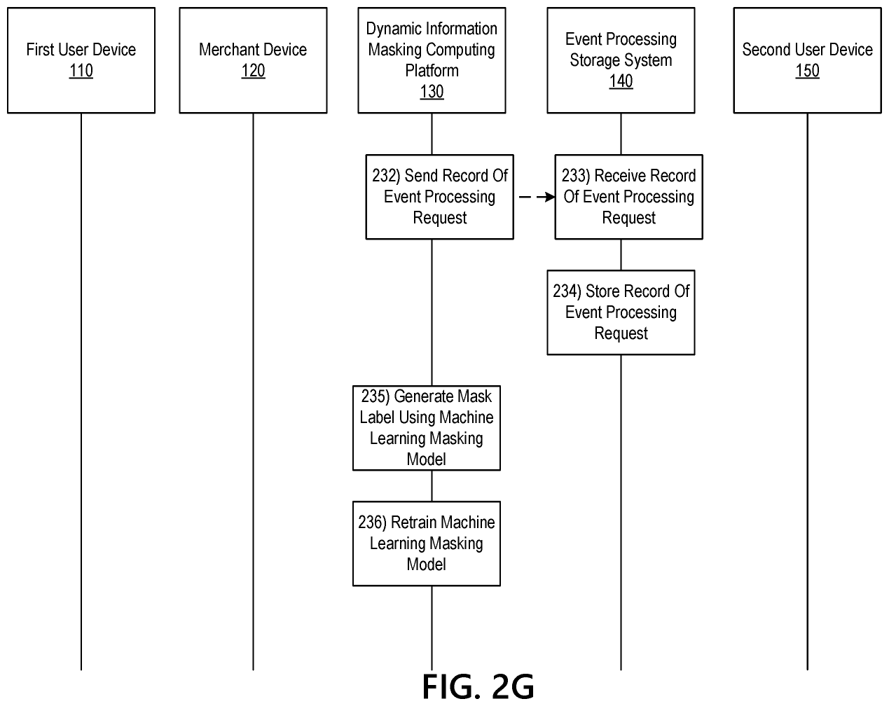

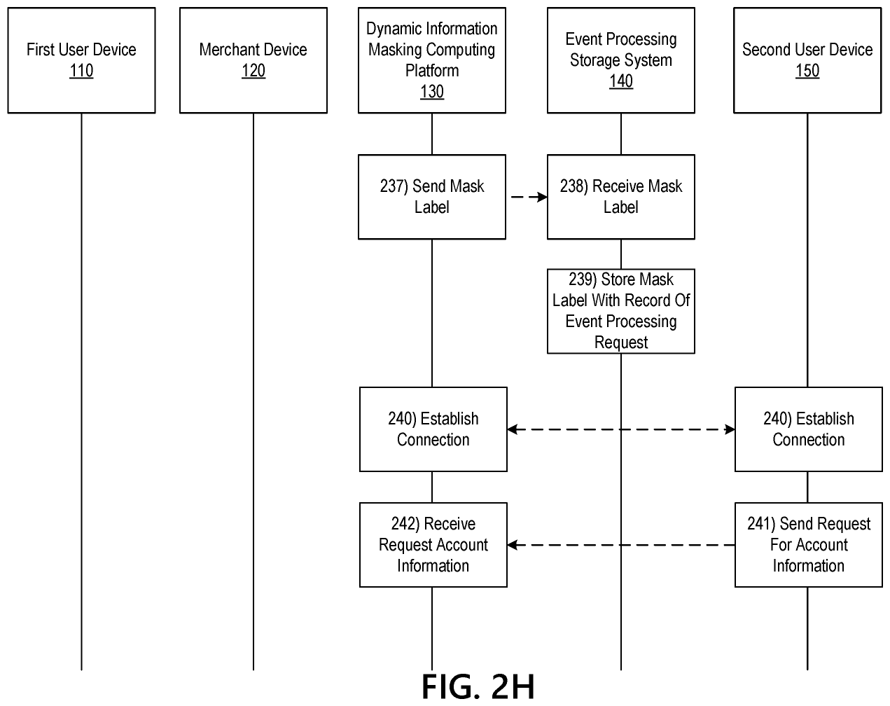

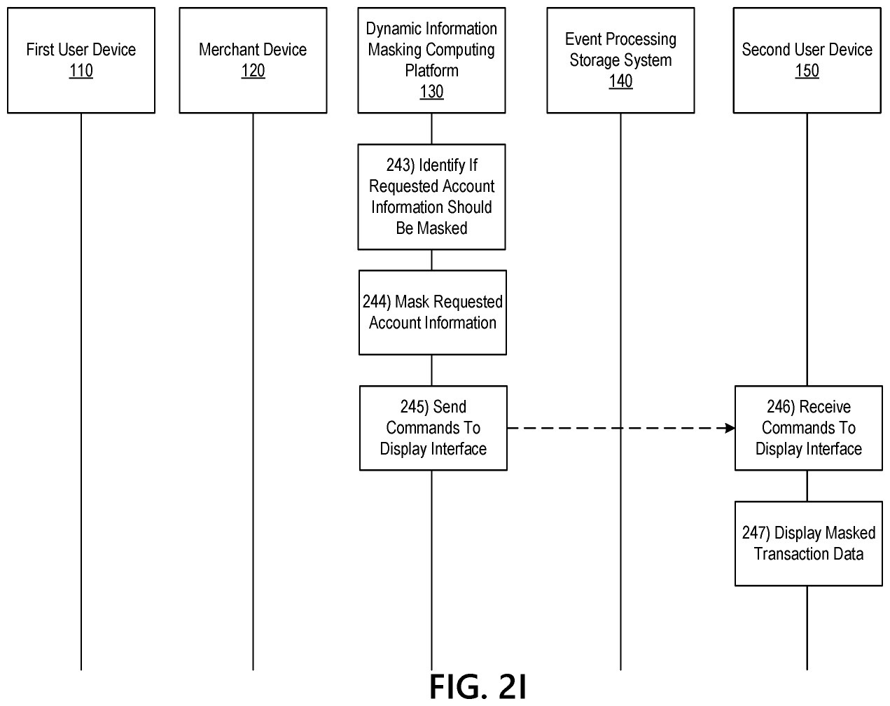

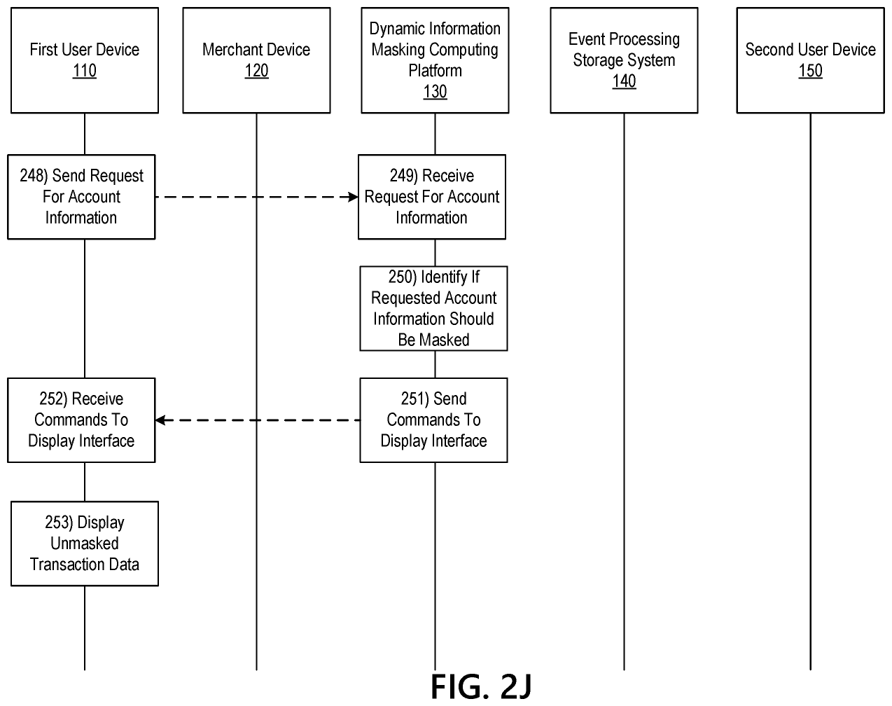

FIGS. 2A-2J depict an illustrative event sequence for dynamically masking event processing requests using a machine learning model in accordance with one or more example embodiments. Referring to FIG. 2A, at step 201, event processing storage system 140 may establish a connection with dynamic information masking computing platform 130. For example, event processing storage system 140 may establish a first wireless data connection with the dynamic information masking computing platform 130 to link the dynamic information masking computing platform 130 with the event processing storage system 140 (e.g., in preparation for sending historical event masking information). In some instances, the event processing storage system 140 may identify whether or not a connection is already established with the dynamic information masking computing platform 130. If a connection is already established with the dynamic information masking computing platform 130, the event processing storage system 140 might not re-establish the connection. If a connection is not yet established with the dynamic information masking computing platform 130, the event processing storage system 140 may establish the first wireless data connection as described above.

At step 202, once a connection has been established, the event processing storage system 140 may send historical event masking information to the dynamic information masking computing platform 130. For example, the event processing storage system 140 may send the historical event masking information while the first wireless data connection is established.

In some instances, in sending the historical event masking information, the event processing storage system 140 may send prior event processing requests, determinations of whether to mask records of the prior event processing requests made by a first user, mask labels corresponding to the records of the prior event processing requests, and/or other information. In some instances, the prior event processing requests may include commercial transactions, currency transfers, and/or other activities. In some instances, the prior event processing requests may have been made by the first user via the first user device 110 and/or a banking device, mobile device, application, and/or other methods.

Additionally or alternatively, in sending the historical event masking information, the event processing storage system 140 may send prior event processing requests, determinations of whether to mask records of the prior event processing requests made by a third user different than the first and second users, mask labels corresponding to the records of the prior event processing requests, and/or other information. The third user may be from and/or correspond to the same geographic region (e.g. a neighborhood, city, state, and/or other geographic region) as the first user. In some instances, the prior event processing requests may include commercial transactions, currency transfers, and/or other activities. In some instances, the prior event processing request may have been made by the third user via a banking device, mobile device, application, and and/or other methods.

At step 203, dynamic information masking computing platform 130 may receive the historical event masking information from event processing storage system 140. For example, the dynamic information masking computing platform 130 may receive the historical event masking information via the communication interface 133 and while the first wireless data connection is established. In some instances, the historical event masking information may be stored in internal memory of dynamic information masking computing platform 130, and/or external memory.

At step 204, the dynamic information masking computing platform 130 may configure and/or otherwise train the machine learning masking model based on the data received at step 203. In some instances, to configure and/or otherwise train the machine learning masking model, dynamic information masking computing platform 130 may process all (or a subset) of the data received at step 203 by applying natural language processing and/or other processing techniques/algorithms to generate and store one or more classification models.

For example, in configuring and/or otherwise training the machine learning masking model, dynamic information masking computing platform 130 may apply natural language processing to the historical event masking information to identify keywords in the prior event processing requests to group the prior event processing requests based on those identified keywords. For instance, the dynamic information masking computing platform 130 may identify that all event processing requests corresponding to a commercial transaction at a particular retail store should be grouped together. Additionally or alternatively, the dynamic information masking computing platform 130 may mine the historical event masking information to determine what mask labels correspond to prior event processing requests containing identified keywords and group the prior event processing requests into categories based on those mask labels. For example, based on the historical event masking information received at step 203, the dynamic information masking computing platform may identify that all event processing requests corresponding to a commercial transaction with a corresponding mask label of “groceries” should be grouped together.

Additionally or alternatively, in configuring and training the machine learning masking model, dynamic information masking computing platform 130 may also analyze the historical event masking information for past user determinations of whether or not to mask the record of an event processing request (e.g., a transaction record) to determine whether or not a particular mask label should be applied to a corresponding category of event processing requests. For example, based on the first user's past determinations to mask all event processing requests in a category named “clothing” with a mask label of “groceries,” the dynamic information masking computing platform 130 may instruct the machine learning masking model to automatically apply the mask label “groceries” to future event processing requests in the “clothing” category. Additionally or alternatively, the dynamic information masking computing platform may give the machine learning masking model this instruction based on the first user's past determinations and/or the third user's past determinations.

At step 205, first user device 110 may establish a connection with merchant device 120. For example, the first user device 110 may establish a second wireless data connection with the merchant device 120 to link the first user device 110 with the merchant device 120 (e.g., in preparation for sending event processing requests). In some instances, the first user device 110 may identify whether or not a connection is already established with the merchant device 120. If a connection is already established with the merchant device 120, the first user device 110 might not re-establish the connection. If a connection is not yet established with the merchant device 120, the first user device 110 may establish the second wireless data connection as described above.

Referring to FIG. 2B, at step 206, the first user device 110 may send an event processing request to the merchant device 120. For example, the first user device 110 may send the event processing request to the merchant device 120 via the communication interface 133 and while the second wireless data connection is established. In some instances, in sending the event processing request, the first user device 110 may send one or more of: a commercial transaction, a currency/fund transfer, and/or other information. For example, the first user device 110 may send the merchant device 120 a request to initiate a transaction for a retail item (e.g., a candy bar).

At step 207, the merchant device 120 may receive the event processing request from the first user device 110. For example, the merchant device 120 may receive the event processing request while the second wireless data connection is established.

At step 208, merchant device 120 may establish a connection with dynamic information masking computing platform 130. For example, the merchant device 120 may establish a third wireless data connection with the dynamic information masking computing platform 130 to link the merchant device 120 with the dynamic information masking computing platform 130. In some instances, the merchant device 120 may identify whether or not a connection is already established with the dynamic information masking computing platform 130. If a connection is already established with the dynamic information masking computing platform 130, the merchant device might not re-establish the connection. If a connection is not yet established with the dynamic information masking computing platform 130, the merchant device 120 may establish the third wireless data connection as described above.

At step 209, the merchant device 120 may route the event processing request (e.g., the event processing request received at step 207) to the dynamic information masking computing platform 130. For example, the merchant device 120 may route the event processing request while the third wireless data connection is established. In some instances, this request may have the same or slightly additional information as the event processing request received from the first user device 110 at step 207.

At step 210, the dynamic information masking computing platform 130 may receive the event processing request from the merchant device 120. For example, the dynamic information masking computing platform 130 may receive the event processing request via the communication interface 133 and while the third wireless data connection is established.

At step 211, the dynamic information masking computing platform 130 may identify whether to approve or deny the event processing request. In some instances, the dynamic information masking computing platform 130 may make this identification based on information corresponding to the first user. For example, the dynamic information masking computing platform 130 may identify whether to approve or to deny the event processing request based on the amount of funds the first user has access to at a financial institution, and/or other information.

Referring to FIG. 2C, at step 212, based on or in response to making the identification of whether to approve or to deny the event processing request at step 211, the dynamic information masking computing platform 130 may generate one or more commands directing the merchant device 120 to process the event. For example, the dynamic information masking computing platform 130 may generate commands indicating whether the event processing request should be approved or denied.

At step 213, the dynamic information masking computing platform 130 may send the one or more commands to the merchant device 120. For example, the dynamic information masking computing platform 130 may send the one or more commands to the merchant device 120 via the communication interface 133 and while the third wireless data connection is established.

At step 214, the merchant device 120 may receive the one or more commands directing the merchant device 120 to process the event. For example, the merchant device 120 may receive the one or more commands directing the merchant device 120 to process the event while the third wireless data connection is established. In some examples, based on or in response to the one or more commands directing the merchant device 120 to process the event, the merchant device 120 may process the event (e.g., execute a transaction, perform a transfer of funds, and/or otherwise process an event). In some instances, the merchant device 120 may then perform its own functions or execute its own processes on the event processing request separate from the one or more commands received form the dynamic information masking computing device 130.

At step 215 the merchant device 120 may send an event processing confirmation to the dynamic information masking computing platform 130. For example, the merchant device 120 may send the event processing confirmation to the dynamic information masking computing platform 130 via the communication interface 133 and while the third connection is established. In some instances, in sending the event processing confirmation, the merchant device 120 may send information indicating that the merchant device 120 received and executed the one or more commands to process the event received from the dynamic information masking computing platform 130 at step 214 (and thus processed the event (e.g., transaction, fund transfer, and/or other event) accordingly).

At step 216 the dynamic information masking computing platform 130 may receive the event processing confirmation sent by the merchant device 120. For example, the dynamic information masking computing platform 130 may receive the event processing confirmation via the communication interface 133 and while the third wireless data connection is established.

At step 217, using the event processing confirmation, the dynamic information masking computing platform 130 may generate a record of the event processing request. For example, the dynamic information masking computing platform 130 may generate transaction and/or other information that may identify that the event processing request was processed, and may be accessible by users (e.g., via an online banking portal and/or other account).

Referring to FIG. 2D, at step 218, based on or in response to receiving the event processing confirmation from the merchant device 120, the dynamic information masking computing platform 130 may identify a confidence score corresponding to the event processing request (and which may e.g., indicate a confidence that a record corresponding to the event processing request should be masked). In some instances, the confidence score may be generated by the dynamic information masking computing platform 130 using the machine learning masking model. The dynamic information masking computing platform 130 may train the machine learning masking model/algorithm to use the historical event masking information to generate the confidence score. In some instances, the algorithm may include dividing a number of prior masked records of event processing requests corresponding to a same record type for the first user by a total number of records corresponding to the same record type to produce a confidence score. For example, the model may identify a number of records corresponding to transactions at a particular enterprise, business, store, or other organization that have been masked, and divide that number by a total number of records corresponding to transactions for that particular enterprise, business, store, or other organization. In some instances, rather than records for an exact business, the records may be for a particular category (e.g., a percentage of transactions at a particular type of store). In some instances, in generating the confidence score, the dynamic information masking computing platform 130 may generate one or more of: a decimal value, a percentile, a binary value, and/or other value. In some instances, dynamic information masking computing platform 130 may identify a record type corresponding to the record of the event processing request. For example, the dynamic information masking computing platform 130 may identify a particular category of event processing request (e.g., all transactions with a certain vendor, and/or all transactions over a certain amount of money, and/or other transaction categories).

In another example, the algorithm may additionally comprise adding a number of prior masked records for a separate user to the number of prior masked records for the first user to generate a sum. In some instances, the separate user may correspond to a same demographic group as the first user. The demographic group may be identified by one or more of a geographic region, a median household income, a relationship status, an education level, and/or other demographics information. The algorithm may further comprise dividing the sum by a total number of records of event processing requests of a same record type to produce the confidence score. The algorithm may perform the steps described above based on an equation, such as:

$$\frac{\begin{matrix}( Prior Masked Records for Seperate Users + \\ Prior Masked Records for First User )\end{matrix}}{Total Records of Same Record Type} = Confidence Score .$$

In doing so, the model may identify whether or not to mask a particular record based on the historical masking decisions of other similarly situated users, which may, in some instances, allow the model to make masking determinations for a user without prior masking information for that particular user (e.g., preferences for the particular user may be predicted based on those of the similarly situated users).

At step 219, the dynamic information masking computing platform 130 may use the machine learning masking model to compare the confidence score to a first confidence threshold. For example, the first confidence threshold may be represented by one or more of a decimal value, a percentile, a binary value, and/or other value. In some instances, the first confidence threshold may be chosen by the first user. In some examples, the first confidence threshold may be selected by the dynamic information masking computing platform 130. For example, the first confidence threshold may be 0.9, and a confidence score of 0.95 would pass the first confidence threshold, but a confidence score of 0.85 would not pass the first confidence threshold. In some instances, the dynamic information masking computing platform 130 may identify that the confidence score meets or exceeds the first confidence threshold. In other instances, the dynamic information masking computing platform 130 may identify that the confidence score does not exceed the first confidence threshold. In some instances, the dynamic information masking computing platform 130 may dynamically adjust the first confidence threshold based on a predetermined percentage of confidence scores that should meet or exceed the first confidence threshold. For example, if the predetermined percentage is 20%, and the dynamic information masking computing platform 130 identifies that a percentage of confidence scores exceeding the first confidence threshold is less than or greater than 20%, the dynamic information masking computing platform 130 may adjust the first confidence threshold accordingly.

At step 220, based on the comparison of the confidence score to the first threshold, the dynamic information masking computing platform 130 may generate masking decision data corresponding to the record of the event processing request. To generate the masking decision data, the dynamic information masking computing platform 130 may have the machine learning masking model identify whether the confidence score exceeds the first confidence threshold. The machine learning masking model may identify whether the confidence score exceeds the first confidence threshold using an algorithm. For example, the algorithm may be: if the confidence score is ≥the first confidence threshold the record should be automatically masked, but if the confidence score <the first confidence threshold, the record should not be automatically masked. For example, if the confidence score meets or exceeds the first confidence threshold, the machine learning masking model may generate masking decision data indicating that the record of the event processing request should be masked. If the confidence score does not exceed the first confidence threshold, the machine learning masking model may generate masking decision data indicating that further analysis should be performed to identify whether or not to mask the record of the event processing request. In some instances, if the dynamic information masking computing platform 130 identifies that the record should be automatically masked, it may proceed to step 229. If instead, the dynamic information masking computing platform 130 identifies that the records should not be automatically masked, it may proceed to step 221.

At step 221, the dynamic information masking computing platform 130 may use the machine learning masking model to compare the confidence score to a second confidence threshold lower than the first confidence threshold. For example, the second confidence threshold may be represented by one or more of a decimal value, a percentile, a binary value, and/or other value. In some instances, the second confidence threshold may be chosen by the first user. In another example, the second confidence threshold may be selected by the dynamic information masking computing platform 130. For example, the second confidence threshold may be 0.7, and a confidence score of 0.75 would pass the second confidence threshold, but a confidence score of 0.65 would not pass the second confidence threshold. In some instances, the dynamic information masking computing platform 130 may dynamically adjust the second confidence threshold based on a predetermined percentage of confidence scores that should meet or exceed the first confidence threshold. For example, if the predetermined percentage is 20%, and the dynamic information masking computing platform 130 identifies that a percentage of confidence scores exceeding the second confidence threshold is less than or greater than 20%, the dynamic information masking computing platform 130 may adjust the second confidence threshold accordingly. In some instances, the dynamic information masking computing platform 130 may identify that the confidence score meets or exceeds the second confidence threshold. In other instances, the dynamic information masking computing platform 130 may identify that the confidence score does not exceed the second confidence threshold.

Referring to FIG. 2E, at step 222, based on the comparison of the confidence score to the second confidence threshold, the dynamic information masking computing platform 130 may generate masking decision data corresponding to the record of the event processing request. To generate the masking decision data, the dynamic information masking computing platform 130 may have the machine learning masking model determine whether the confidence score exceeds the second confidence threshold. The machine learning masking model may identify whether the confidence score exceeds the second confidence threshold using an algorithm. The algorithm may be: if the confidence score is ≥the second confidence threshold user input is required to identify whether the event should be masked, but if the confidence score <the first confidence threshold, user input is not required and the record should not be masked. For example, if the confidence score meets or exceeds the second confidence threshold, the machine learning masking model may generate masking decision data indicating that the record of the event processing request requires user input. If the confidence score does not exceed the second confidence threshold the machine learning masking model may generate masking decision data indicating that the record of the event processing request should not be masked.

At step 223 the first user device 110 may establish a connection with the dynamic information masking computing platform 130. For example, the first user device 110 may establish a fourth wireless data connection with the dynamic information masking computing platform 130 to link the first user device 110 with the dynamic information masking computing platform 130. In some instances, the first user device 110 may identify whether or not a connection is already established with the dynamic information masking computing platform 130. If a connection is already established with the dynamic information masking computing platform 130, the first user device 110 may not re-establish the connection. If a connection is not yet established with the dynamic information masking computing platform 130, the first user device 110 may establish the fourth wireless data connection as described above.

At step 224, based on the masking decision data, the dynamic information masking computing platform 130 may send one or more commands directing the first user device 110 to prompt for further masking decision data. For example, if the masking decision data indicates that the record of the event processing request should not be masked, the dynamic information masking computing platform 130 may proceed to step 229. In other examples, if the masking decision data indicates that the record of the event processing request requires user input, the dynamic information masking computing platform 130 may send one or more commands directing the first user device 110 to prompt for masking decision data. For example, the dynamic information masking computing platform 130 may send the one or more commands directing the first user device 110 to request the first user to prompt for masking decision data via the communication interface 133 and while the fourth wireless data connection is established. In some instances, the first user device 110 may correspond to the first user.

At step 225, the first user device 110 may receive the one or more commands directing the first user device 110 to prompt for masking decision data. For example, the first user device 110 may receive the one or more commands directing the first user device 110 to prompt for masking decision data via the communication interface 133 and while the fourth wireless data connection is established.

At step 226, based on or in response to the one or more display commands directing the first user device 110 to prompt for masking decision data, the first user device 110 may display a masking recommendation interface. In some instances, the masking recommendation interface may be configured to receive user input through the first user device 110.

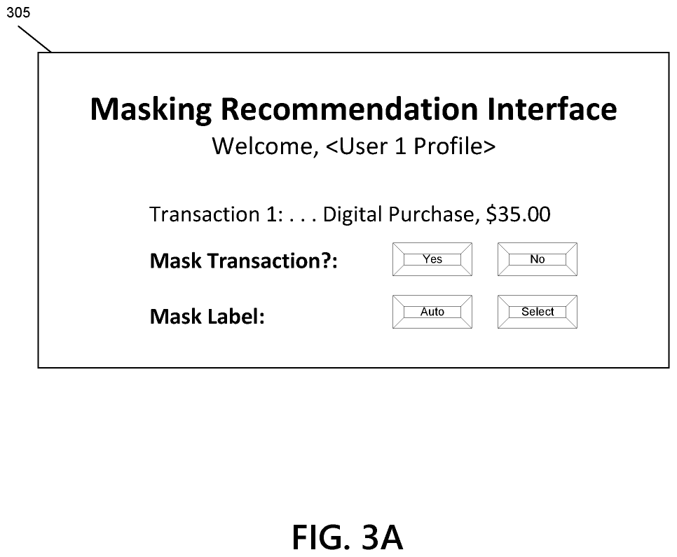

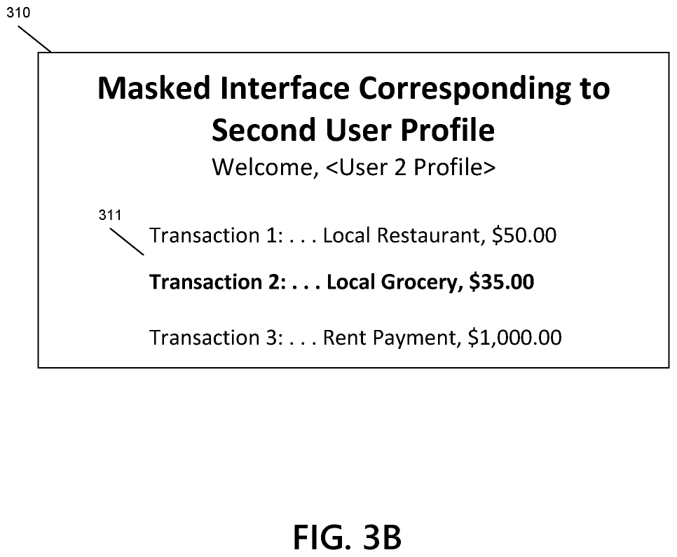

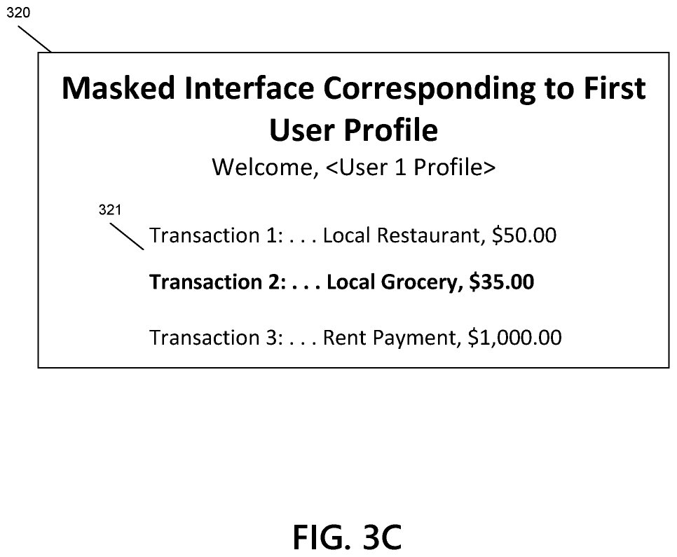

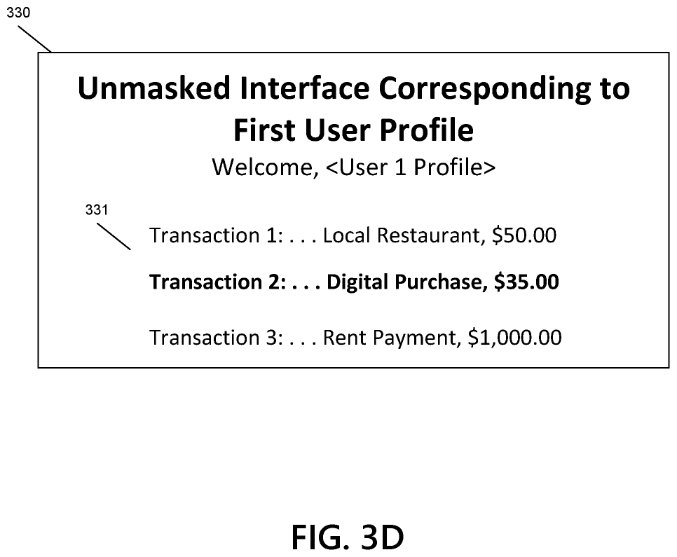

For example, in displaying the masking recommendation interface, the first user device 110 may display a graphical user interface similar to graphical user interface 305, which is illustrated in FIG. 3A. Referring to FIG. 3A, in some instances, the masking recommendation interface 305 may include information corresponding to the event processing request. For example, the masking recommendation interface 305 may include information corresponding to a transaction such as the vendor, the category of the transaction, the monetary value of the transaction, and/or other information. The masking recommendation interface 305 may also display input mechanisms requesting user input. For example, the first user device 110 may display one or more of: a button or buttons, toggle or toggles, check box or boxes, and/or other user interface elements. For example, as illustrated in FIG. 3A the input mechanisms may be buttons the user can select to decide whether or not to mask a transaction, and/or whether to automatically or manually select a mask label.

Additionally or alternatively, the masking recommendation interface 305 may display a recommendation. The recommendation may include one or more of a recommendation of whether or not to mask the record of the event processing request, a recommendation of what mask label to apply to the record of the event processing request, and/or other recommendation information.

Referring to FIG. 2F, at step 227, the first user device 110 may, through the masking recommendation interface 305, receive user input. For example, in receiving the user input, the first user device 110 may include one or more of: a determination of whether or not to mask the record of the event processing request, a determination of what mask label to apply to the record of the event processing request, labeling information from the first user identifying the category of the event processing request, and/or other information.

At step 228, the first user device 110 may send user input information (e.g., based on the user input) to the dynamic information masking computing platform 130. For example, the first user device 110 may send the user input information via the communication interface 133 and while the second wireless data connection is established.

At step 229, the dynamic information masking computing platform 130 may receive the user input information from the first user device 110. For example, the dynamic information masking computing platform 130 may receive the user input via the communication interface 133 and while the second wireless data connection is established.

At step 230 the dynamic information masking computing platform 130 may update masking decision data based on one or more of: the comparison of the confidence score to the first confidence threshold at step 220, the comparison of the confidence score to the second confidence threshold at step 222, and/or the user input received at step 227. For example, the dynamic information masking computing platform 130 may update (e.g., reinforce) the masking decision data to indicate that no further analysis is necessary and that the record of the event processing request should not be masked. In another example, the dynamic information masking computing platform 130 may update the masking decision data to indicate that no further analysis is necessary and that the record of the event processing request should be masked with a specific mask label.

At step 231, the dynamic information masking computing platform 130 may integrate the masking decision data with the record of the event processing request. The record of the event processing request may then include one or more of the masking decision data, the event processing request, information identifying the first user, information indicating what users can access unmasked records of event processing requests, and/or a mask label corresponding to the event processing request. In some instances, the record of the event processing request may also be encrypted. The encryption may be a triple data encryption algorithm, a block cipher, a Rivest-Shamir-Adleman asymmetric cipher, and/or other encryption methods. The encryption may be configured such that only the first user may decrypt the record of the event processing request. For example, there may be a single key associated with a first user profile where the single key may be the only means of decrypting the record of the event processing request. Accordingly, this information may be used to subsequently update and/or otherwise refine the machine learning masking model.

Referring to FIG. 2G, at step 232, the dynamic information masking computing platform 130 may send the record of the event processing request to the event processing storage system 140. For example, the dynamic information masking computing platform 130 may send the record of the event processing request via the communication interface 133 and while the third wireless data connection is established.

At step 233, the event processing storage system 140 may receive the record of the event processing request sent by the dynamic information masking computing platform 130. For example, the event processing storage system 140 may receive the record of the event processing request via the communication interface 133 and while the third wireless data connection is established.

At step 234, the event processing storage system 140 may store the record of the event processing request. In some instances, the record of the event processing request may be stored with other records of event processing requests, thus updating/adding to the historical event masking information. This historical event masking information may later be accessed by the event processing storage system 140 and/or the dynamic information masking computing platform 130 as described herein to make determination about whether or not to mask future event processing records. The event processing storage system 140 may store the record of the event processing request in one or more of a database, a server bank, and the like.

At step 235 the dynamic information masking computing platform 130 may generate a mask label corresponding to the record of the event processing request using the machine learning masking model. The mask label may be a word or combination of words that may be used to mask the record of the event processing request based on or in response to the machine learning masking model identifying that the record of the event processing request should be masked. In some instances, the mask label may be based on the user input. Additionally or alternatively, the mask label may be based on a category of transaction types corresponding to a particular mask label. In some instances, the category of transaction types may be identified by the first user. Additionally or alternatively, the category of transaction types may be chosen by the machine learning masking model based on a type of merchant corresponding to the merchant device 120. Additionally or alternatively, the category of transaction types may be identified by the machine learning masking model based on the historical event masking information. In some instances, the mask label may be generated based on a geographical region, historical transactions, user education, user relationship status, regional income, and/or other demographic information.

At step 236 the dynamic information masking computing platform 130 may retrain the machine learning masking model based on the record of the event processing request. In some instances, the retraining of the machine learning masking model may also incorporate historical event masking information. Retraining the machine learning masking model may include analyzing one or more of the records of the event processing request, labeling information from the first user contained in the masking decision data, and/or the historical event masking information to determine what mask label should apply to future event processing requests.

Referring to FIG. 2H, at step 237, the dynamic information masking computing platform 130 may send the mask label corresponding to the record of the event processing request to the event processing storage system 140. For example, the dynamic information masking computing platform 130 may send the mask label corresponding to the record of the event processing request to the event processing storage system 140 via the communication interface 133 and while the third connection is established.

At step 238, the event processing storage system 140 may receive the mask label corresponding to the record of the event processing request sent by the dynamic information masking computing platform 130. For example, the event processing storage system 140 may receive the mask label corresponding to the record of the event processing request via the communication interface 133 and while the third connection is established.

At step 239, the event processing storage system 140 may store the mask label with the corresponding record of the event processing request. For example, the mask label may be “groceries” and may be stored with a record of a request to complete a transaction at a retail store. In some instances, the record of the event processing request and corresponding mask label may be stored with other records of event processing requests and corresponding mask labels, updating the historical event masking information. This historical event masking information may later be accessed by the event processing storage system 140 and/or the dynamic information masking computing platform 130 as described herein. The event processing storage system 140 may store the record of the event processing request in one or more of a database, a server bank, and the like.

At step 240, the second user device 150 may establish a fifth connection to dynamic information masking computing platform 130. For example, the second user device 150 may establish a first wireless data connection with the dynamic information masking computing platform 130 to link the second user device 150 with the dynamic information masking computing platform 130. In some instances, the second user device 150 may identify whether or not a connection is already established with the dynamic information masking computing platform 130. If a connection is already established with the dynamic information masking computing platform 130, the second user device 150 may not re-establish the connection. If a connection is not yet established with the dynamic information masking computing platform 130, the second user device 150 may establish the fifth wireless data connection as described above. In some instances, the second user device 150 may be a device corresponding to a second user. In some instances, the second user device 150 may be the same device as the first user device 110. In some instances, the second user may be an authorized account holder on an account shared with the first user.

At step 241, the second user device 150 may send a request for account information corresponding to the first user to the dynamic information masking computing platform 130. For example, the second user device 150 may send the request for account information corresponding to the first user via the communication interface 133 and while the fifth wireless data connection is established. The account information may include the record of the event processing request. In some instances, the account information may include multiple records of event processing requests. The account information may correspond to an account with a financial institution. For example, the account may be the first user's checking account at a bank. The request may be a request to view the account information corresponding to the first user (e.g., a monthly statement for the checking account, and/or other records, which may e.g., include transaction records for both the first user and the second user who may both be authorized users for the checking account).

At step 242, the dynamic information masking computing platform 130 may receive the request for account information corresponding to the first user from the second user device 150. For example, the dynamic information masking computing platform 130 may receive the request for account information corresponding to the first user via the communication interface 133 and while the fifth wireless data connection is established.

Referring to FIG. 21, at step 243, the dynamic information masking computing platform 130 may use the machine learning masking model to identify whether some or all of the requested account information should be masked for the second user. In some instances, the first user may have a first user profile corresponding to the account and the second user may have a second user profile corresponding to the account (e.g., different credentials, log in information, account information, and/or other information). Based on the second user profile, the machine learning masking model may identify whether some or all of the record or records of the event processing request or requests included in the requested account information should be masked for the second user profile. For example, the machine learning masking model may identify whether the record of the event processing request indicates which users can access an unmasked version of the record of the event processing request. The record of the event processing request may indicate that only the first user profile has authorization to view an unmasked version of the record of the event processing request, and that the record of the event processing request should be masked for the second user profile. In some instances, the record of the event processing request may indicate that the first user profile only has authorization to view an unmasked version of the record of the event processing request on particular devices corresponding to the first user profile, and that the record of the event processing request should be masked for the first user profile on devices other than the particular devices corresponding to the first user profile.

In some instances, the requested account information may have been encrypted at step 229 (e.g., using a triple data encryption algorithm, a block cipher, a Rivest-Shamir-Adleman asymmetric cipher, and/or other encryption methods). Based on whether or not the second user possesses an encryption key corresponding to the encryption, the machine learning masking model may identify whether some or all of the record or records of the event processing request or requests included in the requested account information should be masked for the second user. For example, the machine learning masking model may identify that the second user device 150 does not possess the encryption key (and/or a corresponding decryption key) and that the record of the event processing request should be masked for the second user device 150. In another example, the machine learning masking model may identify that the second user device 150 does possess the encryption key (and/or a corresponding decryption key), but the machine learning masking model may also identify that the second user profile does not have permission to use the encryption/decryption key, and that the record of the event processing request should be masked accordingly (despite the second user device 150's possession of the encryption/decryption key).

At step 244, based on identifying that some or all of the requested account information should be masked, the dynamic information masking computing platform 130 may use the machine learning masking model to mask the record or records of the event processing request or requests with the corresponding mask label or labels, creating a masked record. For example, the machine learning masking model may identify that a transaction at a retail store should be masked, and link the record of the transaction at the retail store with a corresponding mask label (e.g., “groceries”). The mask label may mask one or more of the amount of money corresponding to the event processing request, the location of the event processing request, the merchant device 120 corresponding to the event processing request, and/or other information. In some instances, the masked record may contain one or more masked records of event processing requests.

At step 245, the dynamic information masking computing platform 130 may send the masked record or records and one or more commands directing the second user device 150 to display the masked record. For example, the dynamic information masking computing platform 130 may send the masked record or records and one or more commands directing the second user device 150 to display the masked record via the communication interface 133 and while the fifth wireless data connection is established. In some instances, in sending the masked record or records and one or more commands, the dynamic information masking computing platform 130 may send a record of a transaction at an electronics retail store masked with a label of “gas” and commands directing the second user device 150 to display the record with that mask label applied to the record.

At step 246, the second user device 150 may receive the masked record and one or more commands to display the masked record. For example, the second user device 150 may receive the masked record and one or more commands to display the masked record via the communication interface 133 and while the fifth wireless data connection is established.

At step 247, based on or in response to the one or more commands to display the account interface, the second user device 150 may display an account interface (e.g., to the second user). In some instances, in displaying the account interface, the second user device 150 may display the masked record.

For example, in displaying the account interface, the second user device 150 may display a graphical user interface similar to graphical user interfaces 310-330, which are illustrated in FIGS. 3B-3D. In some instances, in displaying the account interface, the second user device 150 may display a user profile (e.g., the first user profile, the second user profile, or a third user profile different than the first user profile and the second profile). In some instances, the account interface may also include records of event processing requests and/or additional account information. Based on the masked records, some of the records of the event processing requests may correspond to a mask label (e.g., the records may be masked with the label “groceries”).

In some instances, the account interface may be a masked interface corresponding to the second user profile. For example, the request for account information may have been sent from a second user device 150 corresponding to the second user profile different from the first user device 110 corresponding to the first user profile. This may cause the dynamic information masking computing platform 130 to send one or more commands to display the account interface as the masked interface corresponding to the second user profile. In some instances, the masked interface corresponding to the second user profile may be a graphical user interface similar to the masked interface 310 shown in FIG. 3B.

For example, the masked interface 310 corresponding to the second user profile may include one or more records of event processing requests. For example, the masked interface 310 corresponding to the second user profile may include records of transactions made by the first user. The masked interface 310 corresponding to the second user profile may be displayed on the first user device 110, the second user device 150, and/or any other device. For example, although a transaction record may be visible to a first user's profile within their account, the transaction record may be masked to a second user (who may be an authorized account holder on the same account as the first user) when they attempt to access the account through their own profile. In some instances, some or all of the records of the event processing requests may be masked records. For example, sample masked record 311 shows a record of an event processing request corresponding to a mask label. Sample masked record 311 may correlate to an original unmasked record, such as original unmasked record 331 in FIG. 3D. Sample masked record 311 may display the record of the event processing request with a corresponding mask label. The mask label may mask one or more of the amount of money corresponding to the event processing request, the location of the event processing request, the merchant device 120 corresponding to the event processing request, and the like.

In another example, the account interface may be a masked interface corresponding to the first user profile. For example, the request for account information may have been sent using the first user profile from a second user device 150, where the second user device 150 might not correspond to the first user profile. For example, the second user device 150 might not be authorized to view unmasked records of the event processing requests. This may cause the dynamic information masking computing platform 130 to send one or more commands to display the account interface as the masked interface corresponding to the first user profile. In some instances, the masked interface corresponding to the first user profile may be a graphical user interface similar to the masked interface 320 shown in FIG. 3C.

The masked interface 320 corresponding to the first user profile may include one or more records of event processing requests. For example, the masked interface 320 corresponding to the first user profile may include records of transactions made by the first user. The masked interface 320 corresponding to the first user profile may be displayed on the second user device 150 and/or any other device not corresponding to the first user profile. In some instances, some or all of records of the event processing requests may be masked records. For example, although a transaction record may be visible to a first user's profile within their account, the transaction record may be masked to a second user (who may have access to the first user's profile) when they attempt to access the account from a device not authorized by the first user. For example, sample masked record 321 shows a record of an event processing request corresponding to a mask label. Sample masked record 321 may correlate to an original unmasked record, such as original unmasked record 331 in FIG. 3D. Sample masked record 321 may display the record of the event processing request with a corresponding mask label. The mask label may mask one or more of: the amount of money corresponding to the event processing request, the location of the event processing request, the merchant device 120 corresponding to the event processing request, and/or other information.

Referring to FIG. 2J, at step 248 the first user device 110 may send a request for account information to the dynamic information masking computing platform 130. For example, the first user device 110 may send the request for account information via the communication interface 133 and while the fourth wireless data connection is established. For example, in sending the request for account information, the first user device may request the record of the event processing request. In some instances, the account information may include multiple records of event processing requests. The account information may correspond to an account with a financial institution. For example, the account may be the first user's checking account at a bank. The request may be a request to view the account information corresponding to the first user.

At step 249, the dynamic information masking computing platform 130 may receive the request for account information corresponding to the first user from the first user device 110. For example, the dynamic information masking computing platform 130 may receive the request for account information corresponding to the first user via the communication interface 133 and while the fourth wireless data connection is established.

At step 250, the dynamic information masking computing platform 130 may use the machine learning masking model to identify whether some or all of the requested account information should be masked for the first user. In some instances, the first user may have a first user profile corresponding to the account. Based on the first user profile, the machine learning masking model may identify whether some or all of the record or records of the event processing request or requests included in the requested account information should be masked for the first user profile. For example, the machine learning masking model may analyze the record of the event processing request for information indicating what users can access the unmasked version of the record of the event processing requests. The record of the event processing request may indicate that only the first user profile has authorization to view an unmasked version of the record of the event processing request. In some instances, the record of the event processing request may indicate that the first user profile only has authorization to view the unmasked version of the record of the event processing request on particular devices corresponding to the first user profile, and that the record of the event processing request should be masked for the first user profile on devices other than the particular devices corresponding to the first user profile. In some instances, the dynamic information masking computing platform 130 may identify that the requested account information should be masked for the second user, but not the first user.

At step 251, based on identifying that the requested account information should not be masked, the dynamic information masking computing platform 130 may send the requested account information and one or more commands directing the first user device 110 to display an account interface. For example, the dynamic information masking computing platform 130 may send the requested account information, and one or more commands directing the first user device 110 to display an account interface, via the communication interface 133 and while the fourth wireless data connection is established.

At step 252, the first user device 110 may receive the requested account information and one or more commands directing the first user device 110 to display the account interface. For example, the first user device 110 may receive the requested account information and one or more commands directing the first user device 110 to display the account interface via the communication interface 133 and while the fourth data connection is established.

At step 253, based on or in response to the one or more commands to display the account interface, the first user device 110 may display the account interface to the first user through the first user device 110. For example, in displaying the account interface, the first user device 110 may display a graphical user interface similar to unmasked interface 330, which is illustrated in FIG. 3D. The account interface may be an unmasked interface corresponding to the first profile.

Referring to FIG. 3D, the account interface may be an unmasked interface 330 corresponding to the first user profile. The unmasked interface 330 corresponding to the first user profile may include one or more records of event processing requests. For example, the unmasked interface 330 corresponding to the first user profile may include records of transactions made by the first user. In some instances, some or all of the records of event processing requests may be unmasked. In some instances, some or all of the records of event processing request may be masked records that the first user is authorized to view as unmasked records. For example, a transaction record may be visible to the first user within their account when they attempt to access the account using both the first user's profile and a device authorized by the first user. For example, sample masked record 331 shows a record of an unmasked record of an event processing request that may be masked for profiles other than the first user profile and/or devices not corresponding to the first user profile.

Although these steps as described above are primarily described as being performed by a combination of the dynamic information masking computing platform 130 and the event processing storage system 140, this is for illustrative purposes only. These steps may be performed by the merchant device 120 in combination with the dynamic information masking computing platform 130, or by the dynamic information masking computing platform alone, without departing form the scope of the disclosure.

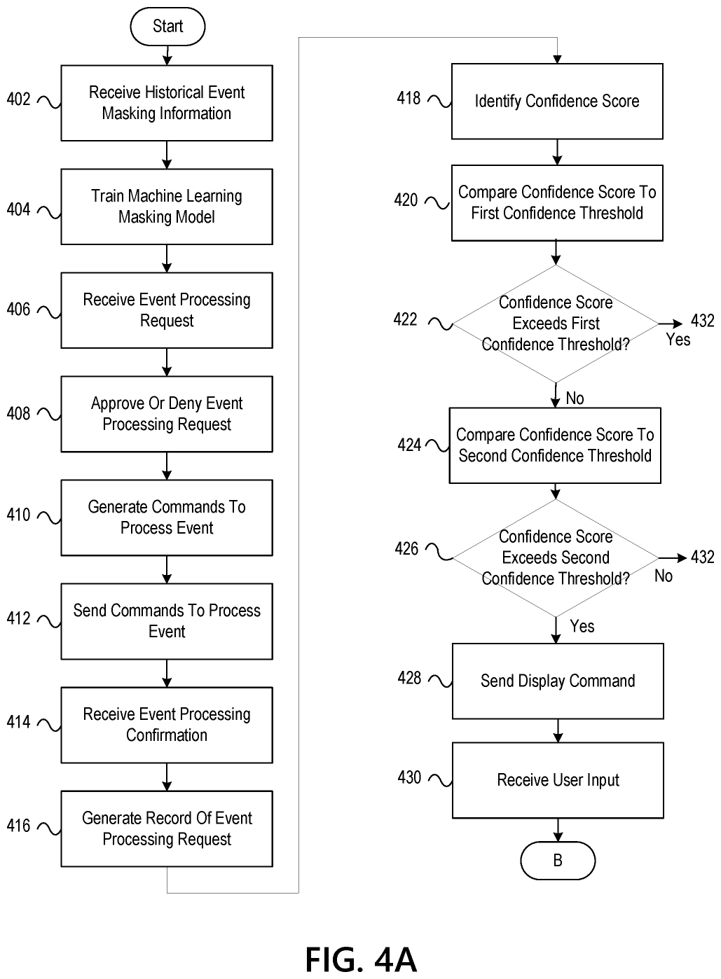

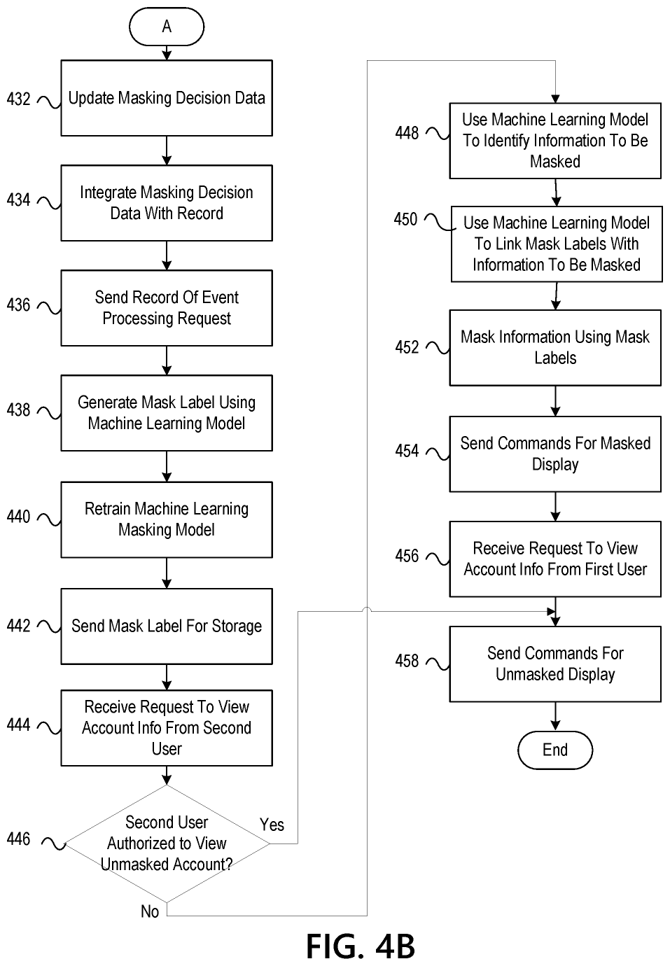

FIGS. 4A and 4B depict an illustrative method for dynamically masking event processing requests using a machine learning model in accordance with one or more example embodiments. Referring to FIG. 4A, at step 402 a computing platform having at least one processor, a communication interface, and memory may receive historical event masking information from an event processing storage system. At step 404, the computing platform may train a machine learning masking model based on the historical event masking information. At step 406, the computing platform may receive an event processing request from one or more merchant devices. At step 408, the computing platform may identify whether to approve or deny the event processing request. At step 410, based on the approval or denial of the event processing request, the computing platform may generate one or more commands to process the event processing request. At step 412, the computing platform may send the one or more commands to process the event processing request to the one or more merchant devices. At step 414, the computing platform may receive event processing confirmation for the event processing request from the one or more merchant devices. At step 416, the computing platform may generate a record of the event processing request.

At step 418, the computing platform may identify a confidence score corresponding to the event processing request using historical event masking information and the machine learning masking model. At step 420, the computing platform may compare the confidence score to a first confidence threshold using the machine learning masking model. At step 422, the computing platform may identify whether or not the confidence score exceeds the first confidence threshold. Based on identifying that the confidence score does exceed the confidence threshold, the method may generate masking decision data indicating that the record of the event processing request should be masked and progress to step 432 in FIG. 4B. Based on identifying that the confidence score does not exceed the confidence threshold, the method may generate masking decision data indicating that further analysis should be performed to identify whether or not to mask the record of the event processing request and may progress to step 424. At step 424, the computing platform may compare the confidence score to a second confidence threshold.

At step 426, the computing platform may identify whether or not the confidence score exceeds the second confidence threshold. Based on identifying that the confidence score does not exceed the confidence threshold, the method may generate masking decision data indicating that the record of the event processing request should not be masked and may progress to step 432 in FIG. 4B. Based on identifying that the confidence score does exceed the confidence threshold, the method may progress to step 428. At step 428, the computing platform may send one or more commands to display a masking decision interface to a first user device. At step 430, the computing platform may receive masking decision from the first user device, where the masking decision is based on user input from a first user.

Referring to FIG. 4B, at step 432, the computing platform may update the masking decision data based on step 422, step 426, and/or step 430. At step 434, the computing platform may integrate the masking decision data into the record of the one or more event processing request. The record of the event processing request may contain the event processing request, the masking decision data, information identifying the first user, information indicating what users can access unmasked records of event processing requests, and/or other information.

At step 436, the computing platform may send the record of the event processing request to a storage system. The storage system may be an event processing storage system. The storage system may store the record of the event processing request with historical event masking information. The historical event masking information may contain one or more other records of event processing requests. At step 438, the computing platform may generate a mask label using the machine learning masking model. The mask label may correspond to the record of the event processing request. The mask label may be used to mask data based on or in response to the machine learning masking model identifying that the data should be masked. At step 440, the computing platform may retrain the machine learning masking model. Retraining of the machine learning masking model may incorporate historical event masking information. Retraining the machine learning masking model may include identifying one or more of: the record of the event processing request, labeling information from the first user contained in the masking decision data, the historical event masking information to identify which mask label should apply to the record of the event processing request, and/or other information.

At step 442, the computing platform may send the mask label to the storage system. The storage system may store the mask label with the corresponding record of the event processing request. At step 444, the computer platform may receive one or more requests to view account information from a second user device. The second user device may correspond to a second user. The account information may correspond to an account corresponding to the first user. The account information may include one or more records of event processing requests. At step 446, the computing platform may identify whether the second user is authorized to view unmasked account information. The identification may be based on one or more of: the device the second user's request originated from, the profile corresponding to the second user, possession of an encryption key, and/or other methods. Based on identifying that the second user is authorized to view the unmasked account information, the method may progress to step 458. Based on a determination that the second user is not authorized to view the unmasked account information, the method may progress to step 448.

At step 448, the computing platform use the machine learning masking model to identify what account information to be masked. At step 450, the computing platform may use the machine learning masking models to link a mask label with the corresponding account information to be masked. At step 452, the computing platform may mask the account information to be masked with the corresponding mask labels. At step 454, the computing platform may send one or more commands to display masked account information to the second user device. At step 456, the computing platform may receive one or more requests to view account information from the first user. The computing platform may identify that the one or more requests originated from the first user based on one or more of: the first user profile, the first user device, possession of an encryption key, and/or other methods. At step 458, the computing platform may send one or more commands to display unmasked account information to the first user device.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform, comprising:
at least one processor;
a communication interface communicatively coupled to the at least one processor; and
memory storing computer-readable instructions that, when executed by the at least one processor, cause the computing platform to:
receive, via a merchant device, an event processing request from a device corresponding to a first user;
generate, using a machine learning masking model, masking decision data indicating that a record of the event processing request should be masked;
receive, from a device corresponding to a second user, a request for account information corresponding to the first user, wherein the account information includes the record of the event processing request;
based on the masking decision data, mask the record of the event processing request; and
send the masked record and one or more commands directing the device corresponding to the second user to display an account interface that includes the masked record to the device corresponding to the second user, wherein sending the masked record and one or more commands causes the device corresponding to the second user to display the account interface that includes the masked record.

2. The computing platform of claim 1, wherein the memory stores additional computer-readable instructions that, when executed by the at least one processor, cause the computing platform to:
using the machine learning masking model, generate a mask label corresponding to the masking decision data and the record of the event processing request, wherein the mask label is generated based on historical event masking information.

3. The computing platform of claim 2, wherein the historical event masking information comprises one or more of: past transactions made by the first user or masking decision data indicating whether or not to mask the past transactions made by the first user.

4. The computing platform of claim 2, wherein the historical event masking information comprises:
past transactions made by a third user, different than the first user and the second user, the third user corresponding to a same geographic region as the first user, and
masking decision data indicating whether or not to mask the past transactions made by the third user.

5. The computing platform of claim 2, wherein the memory stores additional computer-readable instructions that, when executed by the at least one processor, cause the computing platform to:
using the machine learning masking model, place, based on the mask label, the record of the event processing request in a category of transaction types, wherein placing the record of the event processing request into the category of transaction types causes the record of the event processing request to receive a particular mask label, based on a corresponding category.

6. The computing platform of claim 5, wherein the machine learning masking model receives labeling information from the first user identifying the category of transaction types.

7. The computing platform of claim 5, wherein the machine learning masking model identifies the category of transaction types based on a type of merchant corresponding to the merchant device.

8. The computing platform of claim 1, wherein the device corresponding to the second user is the same as the device corresponding to the first user.

9. The computing platform of claim 1, wherein the second user is an authorized account holder on an account shared with the first user.

10. The computing platform of claim 1, wherein the memory stores additional computer-readable instructions that, when executed by the at least one processor, cause the computing platform to:
identify, based on a second user profile, whether the record of the event processing request should be masked for the second user profile, wherein the second user profile corresponds to the second user and wherein a first user profile corresponds to the first user.

11. The computing platform of claim 1, wherein the memory stores additional computer-readable instructions that, when executed by the at least one processor, cause the computing platform to:
identify, based on the device corresponding to the second user, whether the record of the event processing request should be masked for the device corresponding to the second user.

12. The computing platform of claim 1, wherein the memory stores additional computer-readable instructions that, when executed by the at least one processor, cause the computing platform to:
encrypt the masked record of the event processing request, generating an encryption; and
identify, based on whether or not the second user possesses an encryption key corresponding to the encryption, whether the record of the event processing request should be masked for the second user.

13. The computing platform of claim 1, wherein the memory stores additional computer-readable instructions that, when executed by the at least one processor, cause the computing platform to:
receive, from an event processing storage system, historical event masking information; and
train, using the historical event masking information, the machine learning masking model, wherein the training comprises:
implementing an algorithm to identify a confidence score, the algorithm comprising dividing a number of prior masked records corresponding to a same record type for the first user by a total number of records corresponding to the same record type, and
comparing the confidence score to a first confidence threshold, wherein records of event processing requests are masked if the confidence score exceeds the first confidence threshold and the records of event processing requests are not masked if the confidence score does not exceed the first confidence threshold.

14. The computing platform of claim 13, wherein the algorithm further comprises:
adding a number of prior masked records for a separate user, corresponding to a same demographic group as the first user, to the number of prior masked records for the first user to generate a sum; and
dividing the sum by a total number of records of the same record type.

15. The computing platform of claim 13, wherein the computing platform is configured to:
compare the confidence score to a second confidence threshold lower than the first confidence threshold; and
based on identifying that the confidence score fails to exceed the second confidence threshold, modify the masking decision data, indicating that the record of the event processing request should not be masked.

16. The computing platform of claim 15, wherein the computing platform is configured to:
based on identifying that the confidence score does not exceed the first confidence threshold but does exceed the second confidence threshold, send one or more display commands to the device corresponding to the first user, wherein the one or more display commands cause the device corresponding to the first user to display a masking recommendation interface, wherein the masking recommendation interface is configured to receive user input.

17. The computing platform of claim 1, wherein the computing platform is configured to:
update, based on the event processing request and the masking decision data, the machine learning masking model.

18. The computing platform of claim 17, wherein the computing platform is further configured to:
store corresponding mask labels with corresponding records of event processing requests.

19. A method comprising:
at a computing device comprising at least one processor, a communication interface, and memory:
receiving, from a merchant device, an event processing request from a device corresponding to a first user;
generating, using a machine learning masking model, masking decision data indicating that a record of the event processing request should be masked;
receiving, from a device corresponding to a second user, a request for account information corresponding to the first user, wherein the account information includes the record of the event processing request;
based on the masking decision data, masking the record of the event processing request; and
sending the masked record and one or more commands directing the device corresponding to the second user to display an account interface that includes the masked record to the device corresponding to the second user, wherein sending the masked record and one or more commands causes the device corresponding to the second user to display an account interface that includes the masked record.

20. One or more non-transitory computer-readable media storing instructions that, when executed by a computing device comprising at least one processor, a communication interface, and memory, cause the computing device to:
receive, from a merchant device, an event processing request from a device corresponding to a first user;
generate, using a machine learning masking model, masking decision data indicating that a record of the event processing request should be masked;
receive, from a device corresponding to a second user, a request for account information corresponding to the first user, wherein the account information includes the record of the event processing request;
based on the masking decision data, mask the record of the event processing request; and
send the masked record and one or more commands directing the device corresponding to the second user to display an account interface that includes the masked record to the device corresponding to the second user, wherein sending the masked record and one or more commands causes the device corresponding to the second user to display an account interface that includes the masked record.
